(19) United States
(12) Patent Application Publication
(10) Pub. No.: US 2006/0218259 A1
(43) Pub. Date: Sep. 28, 2006

(54) Method of communication setup in a network

(75) Inventors: Abdellatif Benjelloun Touimi, Lannion (FR); Aurelien Sollaud, Trebeurden (FR); Bertrand Mathieu, Lannion (FR)

Correspondence Address: GARDNER CARTON & DOUGLAS LLP;ATTN: PATENT DOCKET DEPT., 191 N. WACKER DRIVE, SUITE 3700, CHICAGO, IL, 60606, US

(73) Assignee: France Telecom, Paris (FR)

(21) Appl. No.: 11/387,235

(22) Filed: Mar. 22, 2006

(30) Foreign Application Priority Data
Mar. 22, 2005 (FR) 05 02828

(51) Int. Cl. G06F 15/177

(52) U.S. Cl. 709/221

(57) ABSTRACT

A method of setting up a communication between a plurality of terminals (T1, . . . , Tn) in a network comprises the activation of at least one chosen node (N1, . . . , Nm) of the network. A node is selected beforehand as a function of predetermined criteria, then the presence of possible means of management of communication on this node (N1, . . . , Nm) is thereafter detected. In case of absence of the means of management on the node, means of management of communication are dispatched to the node. This method applies in particular to computer networks that can support teleconferences.

### FIELD OF THE INVENTION

The present invention relates to a method of setting up data communication between a plurality of terminals connected to a network comprising a plurality of network nodes, and more particularly to a method of teleconference deployment.

### BACKGROUND OF THE INVENTION

When a teleconference communication is to be set up between more than two terminals, we speak of a multipoint conference. A widespread type of configuration relates to centralized multipoint conferences, in which the network topology is of star type with a multipoint control unit (MCU), also referred to as a conference bridge, centralized for managing the communications.

This conference bridge (MCU) of centralized type comprises a multipoint controller and possibly one or more multipoint processors for audio, video and data signals. Each multipoint processor (MP) comprises processors consisting in combining the audiovisual streams arriving to construct the output streams, in carrying out a mixing or switching operation on the signals, or in performing the routing of the signals or else the spatial multiplexing of the images into a single image. The multipoint controller MC controls the multipoint conferences.

In the centralized configuration, the conference bridge is therefore a necessary facility required in the network and is separated from the terminals.

In this mode of operation, the terminals are hooked up by virtue of the commands dispatched to the multipoint controller. The conferences, like the terminals, may have identifiers, and a terminal enters a conference in much the same way as a call between terminals.

However, this type of connection is static and allows only weak optimization of the connection and of the occupancy of the bandwidth. Moreover, by reason of the separation of the bridge with respect to the terminals, a transmission delay, a hindrance to interactivity and comfort of communication, is often noted. Furthermore, the whole set of communications is in general centralized on a single conference bridge, this implying that this bridge comprises fairly powerful means for managing the whole set of communications simultaneously.

### SUMMARY OF THE INVENTION

An aim of the present invention is to provide a method of communication between a plurality of terminals making it possible to optimize the occupancy of the bandwidth of the network, and to offer a flexible configuration. Such a method also offers an improvement in the quality of service provided to the users.

The invention thus proposes a method of setting up a data communication between a plurality of terminals connected to a network comprising a plurality of nodes, at least one of which is chosen to set up a communication between the terminals.

According to a currently preferred definition of the invention, at least some of the nodes of the network are configurable nodes and the method comprises the following steps:

a) selection of at least one configurable node of the network as a function of predetermined criteria;

b) detection of the presence of possible means of management of communication on this node; and

c) dispatching of means of management of communication to said node in case of detected absence of the means of management of communication on the node in step b).

The present invention is also aimed at a module intervening in the setting up of a communication between a plurality of terminals connected to a network comprising a plurality of network nodes, the module being connected to said network and comprising means for configuring in such a way as to render active at least one chosen node of the network so as to set up a communication between the terminals.

According to a currently preferred definition of the module within the meaning of the invention, the module comprises:

a. means of selection of at least one configurable node of the network so as to select a node as a function of predetermined criteria, at least some of the nodes of the network being configurable;

b. configuration detection means adapted for detecting the presence of means of management of communication on the node selected;

c. means of uploading for dispatching means of management of communication to said node in case of absence of the means of management of communication, detected by said configuration detection means.

Finally, the invention is also aimed at a computer program product intended to be stored in a memory of a module capable of setting up a communication between a plurality of terminals connected to a network comprising a plurality of network nodes, characterized in that it comprises instructions for:

a) selecting at least one configurable node of the network as a function of predetermined criteria, at least some of the nodes of the network being configurable;

b) determining a configuration of said node by detecting the presence of possible means of management of communication on this node; and

c) dispatching means of management of communication to said node in case of detected absence of the means of management of communication on the node during the execution of instruction b).

By virtue of this invention, it is possible to set up communications in a flexible manner, as a function, for example, of the bandwidth of the network, or of the workload of the node. It is possible to deploy, dynamically, that is to say when there is a need or when possible, a computer program on specific nodes capable of intercepting in real time a data stream and of applying the processing operations of the computer programs to the packets concerned. Moreover, it is possible to choose the most appropriate application as a function of the request and to thus render the telecommunication structure flexible. The expression configurable node is understood to mean a network node able to support processing operations. Thus, the configurable nodes may include programmable nodes comprising means for receiving and executing a computer program, adaptive nodes comprising, for example, an application whose configuration can be modified from outside.

### BRIEF DESCRIPTION OF THE DRAWINGS

Other features and advantages of the present invention will become apparent in the description hereinafter of nonlimiting exemplary embodiments, with reference to the appended drawings, in which:

FIG. 1 represents a network in which a first embodiment of the method according to the invention is implemented;

FIG. 2 represents a network in which a second embodiment of the method in accordance with the invention is implemented;

FIG. 3 is a flowchart in accordance with the method according to the invention; and

FIG. 4 is a schematic diagram of a module in accordance with the invention.

### DETAILED DESCRIPTION OF A PREFERED EMBODIMENT

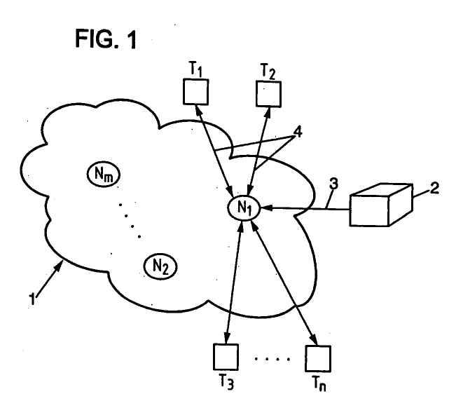

As represented in FIG. 1, a first embodiment of the method in accordance with the invention is implemented in a network 1, to which are connected a plurality of terminals T1 to Tn. Moreover, in this example, the network comprises a plurality of nodes, some of which are programmable N1 to Nm, thus forming a programmable network. In a more general manner, the invention may be implemented with configurable nodes, that is to say ones that can support processing operations.

Programmable networks are networks composed of programmable nodes having the ability to process the packets both at the network level and at the application level. Moreover it is possible to dynamically download computer programs to carry out the processing operations. This type of network is generally seen as an overlay network above the physical network. Additionally, it is also possible for the nodes of the physical network to be programmable themselves.

The principal feature of this embodiment resides in the fact that a single node is rendered active per communication. Thus, if a communication is to be set up between terminals T1 to Tn, at least one of them contacts a multipoint controller. This controller will then signal this request to a module 2, for example, installed on the multipoint controller. This module 2 has, for example, knowledge of the topology of the network 1, possibly of the load of the nodes. The expression current topology of the network is understood to mean the whole set of connections effective at the moment of communication setup. It is therefore in a position to take the decision to select the node which is to be activated so as to manage the data of the new conference by playing the role of the multipoint processor.

In this example, the node selected by the module 2 is the node N1. This selection relies on predetermined criteria, such as for example:
the proximity of the terminals with respect to the node,
the available workload of the node,
the bandwidth of the network in the neighborhood of the node, or else,
a compromise of these various criteria.

The proximity of the terminals may be judged in particular by the number of nodes and of routers separating the terminal from the node, or else a purely geographical distance. The number of terminals in proximity to one and the same node may also be taken into account. The available workload of the node depends in particular on the calculation power of the node, and on the number of tasks currently being executed within the node. It also depends on its reliability or on its failure. The bandwidth in the neighborhood of the network must be significant enough for the communication between the terminals by way of the node to be possible.

Once a node has been selected, for example, the node N1, the module 2 determines which type of means of management is the most apt, then detects the presence of these means of management of communication on this node. For example, these means of management may comprise new protocols supported by the network, new application (Proxy) gateways that can perform processing, monitoring means specific to each protocol, functions of management or of services in the network, means of specific traffic aggregation or of compression/decompression of data making it possible to economize with regard to the resources of the network, means that can perform a change of format, means of mixing and/or multiplexing or of redirection of data.

If these means of management of communication are detected as absent, then the module 2 dispatches the computer program necessary to provide these means of management by means of a dispatch stream 3. One thus obtains great flexibility of functionalities for each node of the network. Once the computer program has been dispatched to the node N1, the latter is activated so as to process the data of the communication 4 between the terminals T1 to Tn.

Furthermore, the module 2 may detect whether the version of the means of management present on the node requires an update. If such is the case, the module 2 dispatches the corresponding update, then the node sets up the communication between the terminals T1 to Tn. It is possible to upload the computer program into the node with a transmission of the data on the data path (“in-band” approach), or by another path (“out-of-band” approach).

Consequently, the implementation of this method allows a reduction in the traffic within the operator network. The audio and video streams are in fact exchanged with the multipoint processor situated on the configurable node, here programmable, closest to the terminals of the participants in the teleconference. Carrying out this operation as near as possible to the terminals allows an optimal procedure for reducing the traffic on the network. Moreover, the probability of packet loss and the delay are reduced since the number of routers crossed is minimized, thereby improving the quality of communication.

Furthermore, the complexity is better distributed within the network. Specifically, a multipoint processor devoted to a conference is executed dynamically (after a possible upload) in a machine situated on a programmable node of the network. In this architecture, only the command part can remain centralized in the controller.

Additionally, this allows dynamic management of the communications. Specifically, when a communication is set up, it is possible to monitor the state of the node-selected N1 by monitoring at least one characteristic of this node, for example a workload of the node, or a bandwidth of the network or else a request for new communications. If the state of this node degrades, for example if the characteristic monitored lies within a span of predetermined values, the module 2 can select another node N2 in accordance with the method explained previously for example, so as to pass the baton to this node N2.

Thus, it is not necessary to forecast in advance the load of the nodes nor to reserve resources beforehand. This notion of conferencing without reservation of resources is very advantageous for the user, since it simplifies the teleconference service and encourages its use spontaneously. Additionally, it allows the operator management on demand of the licensed resources of software for processing signals (coding/decoding, mixing, transcoding, audio denoising, sound spatialization, video composition, etc.) and also other software.

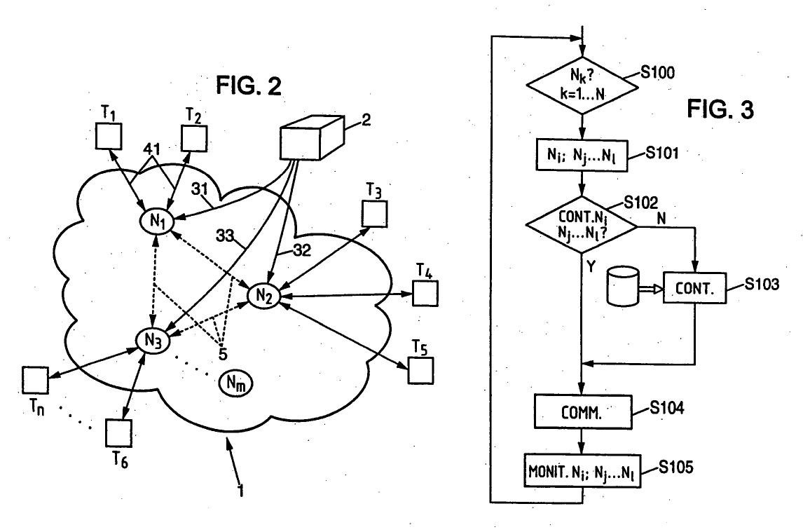

According to another embodiment, in particular represented in FIG. 2, an even more distributed architecture is implemented. In this case, we have n terminals and m nodes and none of the nodes is truly central.

The advantage of this embodiment is the possibility of partial concentration of the media streams as near as possible to the terminals, thus allowing a reduction in the traffic.

In a manner identical to the previous embodiment, to set up a communication, a module 2 performs a selection of nodes according to the criteria described previously. However, instead of choosing a single node, this controller chooses a plurality of nodes, for example, nodes N1 to N3. The number of nodes chosen is not fixed and can vary from one communication to another as a function for example of the number of terminals involved in the communication. Each terminal is allocated to a chosen node. Next, the same operations of determination of configuration and of dispatching of means of management as appropriate are performed. For example, data streams 31, 32 and 33 allow the dispatching of the code of the controller to nodes N1, N2 and N3, respectively.

Finally, the module 2 can render the nodes N1 to N3 active so that each of them sets up a communication between the terminals allocated to this node and the other nodes. Thus, on the one hand, the node N1 communicates with the terminals T1 and T2 according to the communication 41, and on the other hand, communicates with the other nodes according to the communication 5.

There is therefore a better distribution of the occupancy of the network as regards bandwidth and also the nodes. Moreover, the data transfers thus distributed have less significant bit rates which are therefore more supportable in respect of the network.

For example, if the communication involves n terminals and m nodes, each node k possesses a subset of pₖ terminals, and we denote by Xⱼ^{k} the signals sent by terminal i to node k. Consequently, node k receives on the part of the terminals of its subset the signals ⱼ^{k}, 1≦i≦pₖ. A possible processing in this node is the mixing of the audio signals received, that is to say the construction of the signal

$${S}_{k} = {\sum }_{i = 1}^{{p}_{k }} {X}_{i}^{k} .$$

It must therefore transmit this same signal to the whole set of other nodes. Conversely, it receives the sum signals Sⱼ from the other nodes and constructs the signal

$${R}_{k} = {\sum }_{{j = l}_{j \neq k}}^{m} {S}_{j} .$$

Consequently, node k has to transmit to terminal i of its subset the sum of the signal sent by the other terminals of its subset, that is to say Sₖ−Xᵢ^{k}, and of the whole set of data Rₖ originating from the other nodes.

In total, it will transmit the signal

$${\sum }_{j = 1}^{m} {S}_{j} - {X}_{i}^{k}$$

to terminal i of its subset. It is noted consequently that the transmissions requiring a large bandwidth are limited to the communications between the node and the terminal. The communications between nodes require smaller bandwidths, thus avoiding deterioration of the bandwidth over too large a part of the network but only at the level of the terminals.

These two embodiments of the method according to the invention may be applied to all types of conference bridges, and, for example, to:

a mixing audio bridge,

a composition video bridge,

a concatenation audio or video bridge performing the concatenation of several media frames (audio or video) in one and the same packet for IP header factorization.

Additionally, the method can be summarized by the flowchart of FIG. 3. When setting up a communication, the state of the nodes is observed in step S100, so as to determine a node, or possibly a plurality of nodes Ni, Nj, . . . Nl, through which the communication will be carried out during step S101.

Once nodes have been determined, the presence of means of management of communication (CONT. Ni, Nj, . . . Nl?) are detected in step S102. If these means of management of communication are absent from these nodes, the code required for the formation of these means is dispatched to these nodes in step S103.

Finally, the communication (S104) is set up, and the state of the nodes is monitored in step S105 (MONIT. Ni, Nj, . . . Nl). If the state of the nodes requires a change of nodes, this change can be performed, as described previously, according to an identical method of communication setup.

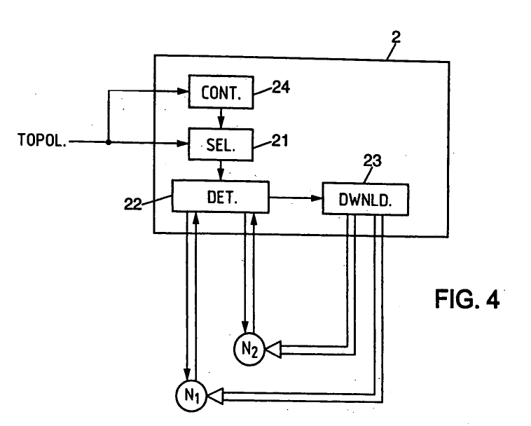

Furthermore, FIG. 4 illustrates an example of a module in accordance with the invention. In this module 2, for example, installed on a multipoint controller, means of selection 21 of nodes receive information on the current topology of the network and on predetermined criteria. These means of selection 21 select at least one node on the basis of these criteria and of the topology, and communicate the list of nodes to configuration detection means 22. The configuration detection means 22 then determine whether the nodes of the list possess communication management means, and give the order as appropriate to downloading means 23 to dispatch these communication management means to the nodes.

When the communication is set up, monitoring means 24 monitor the state of the node and possibly the topology of the network. If they determine that a change is necessary, as was described previously, they command the selection means 21 so that new more apt nodes are chosen.

1. A method of setting up a data communication between a plurality of terminals connected to a network comprising a plurality of network nodes, in which at least one chosen node of the network sets up a communication between the terminals,
in which at least some of the nodes are configurable nodes, the method comprising the following steps:
a) selection of at least one configurable node of the network as a function of predetermined criteria;
b) detection of the presence of possible means of management of communication on this node; and
c) dispatching of means of management of communication to said node in case of detected absence of the means of management of communication on the node in step b).

2. The method according to claim 1, in which said at least one configurable node of the network is selected as a function of criteria predetermined from among at least a topology of the network, a proximity of the terminals, a state of the bandwidth of the network in the neighborhood of the node, an available workload of said node and/or a compromise between these criteria.

3. The method according to claim 1, in which a single configurable node sets up the communication between said terminals.

4. The method according to claim 1, in which a plurality of configurable nodes set up the communication between said terminals.

5. The method according to claim 4, in which during step (a), each node selected is allocated to at least one terminal to set up a communication between said one terminal allocated and the other nodes.

6. The method according to claim 1, in which, in the course of step (b), one determines whether an update of the means of management of communication is necessary, and in which the corresponding update is dispatched during step (c).

7. The method according to claim 1, in which the communication management means dispatched in the course of step (c) are adapted for performing an operation from among at least a data redirection, a data composition, a data compression, a data decompression, a change of format, a mixing, a multiplexing and/or a combination of these operations.

8. The method according to claim 1, in which, once the communication has been set up:
d) at least one characteristic of said configurable node is monitored;
e) at least one new configurable node is chosen if the value of at least one characteristic monitored in the course of step (d) lies in a predetermined span of values.

9. The method according to claim 8, in which the characteristic monitored comprises at least one parameter from among a workload of the node, a bandwidth of the network, a request to set up new communications, and/or a compromise between these parameters.

10. The method according to claim 1, in which the communication is set up for a teleconference between the terminals of a network.

11. A module intervening in the setting up of a communication between a plurality of terminals connected to a network comprising a plurality of network nodes, said module being connected to said network and comprising means for configuring in such a way as to render active at least one chosen node of the network so as to set up a communication between the terminals, said module comprising:
means of selection of at least one configurable node of the network so as to select a node as a function of predetermined criteria, at least some of the nodes of the network being configurable;
configuration detection means adapted for detecting the presence of means of management of communication on the node selected;
means of uploading for dispatching means of management of communication to said node in case of absence of the means of management of communication, detected by said configuration detection means.

12. The module according to claim 11, wherein it is installed in a multipoint controller.

13. A computer program product intended to be stored in a memory of a module capable of setting up a communication between a plurality of terminals connected to a network comprising a plurality of network nodes, the computer program product comprising instructions for:
a) selecting at least one node of the network as a function of predetermined criteria, at least some of the nodes of the network being configurable;
b) determining a configuration of said node by detecting the presence of possible means of management of communication on this node; and
c) dispatching means of management of communication to said node in case of detected absence of the means of management of communication on the node during the execution of instruction b).
